(19) United States
(12) Patent Application Publication
(10) Pub. No.: US 2008/0071587 A1
(43) Pub. Date: Mar. 20, 2008

(54) INCENTIVE WIRELESS COMMUNICATION RESERVATIONS

(76) Inventors: Nicole Janine Granucci, San Francisco, CA (US); James Stretch, El Granada, CA (US)

Correspondence Address: Quarles & Brady LLP, TWO NORTH CENTRAL AVENUE, One Renaissance Square, PHOENIX, AZ, 85004-2391, US

(21) Appl. No.: 11/945,907

(22) Filed: Nov. 27, 2007

Related U.S. Application Data
(63) Continuation-in-part of application No. 11/166,473, filed on Jun. 24, 2005.

(51) Int. Cl. G06Q 10/00

(52) U.S. Cl. 705/5; 379/93.12; 705/14

(57) ABSTRACT

A portable consumer device is used to wirelessly communicate at least payment account data to a reservation system to make a reservation. If the same payment account is used to pay for the reserved good or service, an incentive can be received. Information on the incentive can be received, for example, at the hand held consumer electronic device. Within a hospitality industry environment, a consumer may use a hand held wireless telecommunication device to communicate the payment account number to a reservation broker that makes a reservation for dining at a restaurant. The consumer may also receive confirmation of the reservation at the hand held wireless telecommunication device. The consumer may receive information characterizing an incentive if the same payment account used to make the restaurant reservation is used to pay for the dinning associated with the reservation.

### CROSS-REFERENCE TO RELATED APPLICATIONS

This application is a continuation-in-part application of, and claims priority to, the U.S. patent application Ser. No. 11/166,473, by James C. Stretch and Nicole Janine Granucci, filed on Jun. 24, 2005, titled “System, Apparatus and Methods for Automatically Calculating Discounts for Purchases From Merchants Made Using a Reservation System,” the entire contents of which is hereby incorporated by reference.

### FIELD OF THE INVENTION

This invention relates, in general, to incentive programs that reward a consumer to utilize a payment processing system, and in particular, to incentive programs that reward consumers for making a reservation and paying for an inventory using a payment account within the payment processing system.

### BACKGROUND

Various companies provide reservation services for consumers wherein rewards, points, or discounts are provided to the consumers if the consumers utilize certain credit cards, debit cards, or other preferred payment methods. For instance, dining programs may provide credit cardholders with restaurant reservation services for use with participating restaurants, and if the consumer pays a bill of one of the participating restaurants with a preferred or eligible credit card, then the consumer is awarded a dining discount provided by the restaurant when closing the dinner transaction. Other reservation systems (e.g., hotel, airline, etc.) may provide, through affiliations with banks or credit or payment account companies, rewards, points, or other discounts to the consumer if the consumer utilizes an eligible credit card for payment. In this way, the issuing bank or payment account company benefits by encouraging the consumer to utilize its payment accounts for the particular transaction; the merchant benefits in that more consumers are brought to a business of the merchant; and the consumer benefits by receiving a discount or other award merely for using a payment account that is eligible to complete the transaction.

Despite its advantages, conventional reservation discount/award programs may be subject to a number of implementation problems. Although the consumer may have a payment account that is eligible to make a reservation, it is possible that the consumer may utilize a non-eligible form of payment to close the transaction and still expect a discount. In programs where a consumer is rewarded for dining at a merchant by using an “enrolled” card, the consumer is often not aware of the discount or bonus incentive until after they dine, thus cannibalizing a profit margin of the merchant, as these are not incremental diners. If consumers have convenient access to a reservation system involved in the calculation of the discounts, the consumers may more frequently use the payment account that is eligible to gain the benefits of the discounts.

Some consumers may prefer to have their discounts provided to them in forms other than a cash back reward, such as points, miles, or other forms of reward. Furthermore, there may be little ability to accurately track discounts applied, particularly where the process of rewarding the discounts to the consumer is performed by the merchant before the transaction amount is transmitted to the payment account company.

Where a discount is manually processed by the merchant, the possibility for a data entry error or mathematical calculation error exists. In a busy restaurant setting, a restaurant employee may calculate the discount given to the consumer involved in a reservation discount program, and such calculations may be subject to human error from time to time.

Accordingly, there is a need in the art for automating discounts based on a consumer's use of a payment account that is eligible that is part of a reservation program, such as a controlled-inventory management reservation program.

### SUMMARY

Implementations are directed to communication with a system that calculates an incentive. In one implementation, a first transmission having data to make a reservation with a reservation broker is formed at a portable consumer device such as a hand held wireless telecommunication device. The data can include an indicator of a first payment account associated with a payment processing system such as a credit card number. A second transmission including a confirmation of the reservation is received at the portable consumer device. The confirmation may include an identifier for the reservation, such as the name of a person the reservation is made under, instructions for honoring the reservation, or a time limit in which the reservation may be valid. Information characterizing an incentive, such as a number of bonus miles earned, may be received, for example on the portable consumer device. The incentive may exist for each match of the first payment account used to make the reservation with a second payment account associated with the payment processing system that was used to pay for the reserved good or service.

In another implementation, a hand held consumer wireless telecommunications device has a processor that executes a program. The program, when executed, forms a first transmission having data to make a reservation with a reservation broker, wherein the data includes an indicator of a first payment account associated with a payment processing system. The executed program can also receive a second transmission including a confirmation of the reservation. Moreover, the executed program can receive a third transmission including information characterizing an incentive for each match of the first payment account for the reservation with a second payment account associated with the payment processing system, wherein a transaction associated with the reservation is payable on the second payment account.

In yet another implementation, a first transmission having data to make a reservation with a reservation broker for a party at a restaurant is received at a hand held wireless telecommunication device. The data can include an indicator of a first payment account associated with a payment processing system, a number of expected people in the party, a date of the reservation, and a time of the reservation. A second transmission including a confirmation of the reservation can be received at the hand held wireless telecommunication device. Information characterizing an incentive may also be received, for example, at the hand held wireless telecommunication device. The incentive may exist for each match of the first payment account for the reservation with a second payment account associated with the payment processing system that was used to pay for the reserved good or service at the restaurant.

### DESCRIPTION OF THE DRAWINGS

FIG. 1 illustrates a block diagram of an example of a system for providing automated discounts or rewards, in accordance with one implementation;

FIG. 2 illustrates an example of operations for providing automated discounts for purchases made from merchants as part of a reservation program, in accordance with one implementation;

FIG. 3 illustrates an example of operations which may be performed by a reservation broker, in accordance with one implementation;

FIG. 4 illustrates an example of operations which may be performed by a database or related software or logic, in accordance with one implementation;

FIG. 5 illustrates an example of operations which may be performed by the merchant or a computing system of the merchant, in accordance with one implementation;

FIG. 6 illustrates an example of operations that may be performed by a discount calculation engine to automatically calculate a discount or reward, in accordance with one implementation;

FIG. 7 illustrates an example of a graphical user interface for gathering inventory data to create available reservations from the merchant, in accordance with one implementation;

FIG. 8 illustrates examples of graphical user interfaces for permitting a consumer to view available reservations, make reservations, and select a desired form of discount, in accordance with one implementation;

FIG. 9 illustrates an example of operations that may be performed to receive information characterizing an incentive; and

FIG. 10 shows a block diagram of an exemplary payment system in which the exemplary system depicted in FIG. 1 can be implemented.

### DETAILED DESCRIPTION

Implementations provide for automatic calculation of discounts for consumers that have reserved and purchased goods or services that are payable upon a payment account within the payment processing system from the merchant. The reservation system may be for inventory of the merchant that is provided to the consumer. Examples of the inventory may include: a goods of a manufacturer held in a warehouse, a clothing line of a clothing retailer available for sale, a batch of paper of a paper mill, a seating capacity of an airline over a range of airplanes, a capacity of a restaurant to service dining patrons, or a stock of food of the restaurant for preparation of meals or a doctor's services.

In a business-to-business environment the inventory of the merchant may be an inventory of a manufacture or distributor that is provided to another of the merchants. The reservation can include a purchase order indicating a form of payment for the purchase of a portion of the inventory. The reservation system may include a data management system for the management of an inventory of the merchant.

A reservation within the reservation system includes an indication of the consumer of a desire to purchase or use part of an inventory in the future. Examples of reservations include the consumer: reserving a table at a restaurant, reserving a room at a hotel, reserving an airline ticket, reserving a T-time for a golf course, reserving a conference hall for a convention, or remotely ordering take out food such as placing an order for food using a phone or an Internet website. Another example of a reservation within a reservation system includes a consumer enrolling for a credit card that is associated with the merchant offering goods or services in a predictable pattern such as dinners at a Chili's™ restaurant every Monday between 5:00-7:00 p.m.

The consumer may create a consumer profile in association with at least one account within a payment processing system. In the consumer profile the consumer may indicate different preferences, such as travel or entertainment preferences, or the consumer may indicate a preference for an incentive such as 20% off dinners at a Chili's™ restaurant on Monday nights. The preference of the consumer is then tracked within the reservation system.

Implementations may also permit for the consumer to receive the incentive in various forms, if desired, such as points, miles, rebates, goods, services, or other rewards.

Generally, a consumer can make a reservation with the merchant through a reservation service which offers discounts to the consumer for goods or services purchased from the merchant through use of the payment account that is eligible for the discount. As used herein, the term “payment account” includes but is not limited to, for example, a credit card account, a debit card account, a bank account, a store-issued card account, a prepaid card account, or a health care account such as a flexible spending account. A portable consumer device may be used to communicate account information. The portable consumer device may include a credit card, a contactless card, a portable consumer wireless communication device, a hand held device, a hand held computer, a portable consumer wireless telecommunication device, a phone, a hand held telecommunication device, a cellular telephone, a hand held computer, a personal digital assistant, a pager, a smart media, a transponder, a laptop personal computer, a virtual cash register, any cards that a consumer can use in lieu of a cash payment, or any form of electronic payment, each of which are used interchangeably herein.

A reservation file 24, described below, is generated and transmitted to a database for access by a discount calculation engine. After the consumer completes the purchase from the merchant using the payment account that is eligible, the calculation engine automatically calculates the amount of the incentive and optionally generates a credit to the payment account of the consumer and generates a debit to the merchant. The incentive can be optionally recorded, in a database for example, for later analysis and processing. In this way, the calculation of the discount is automatic and accurate, and can be included in a statements of the payment account of the consumer and payment account activity summaries such as year-end summaries.

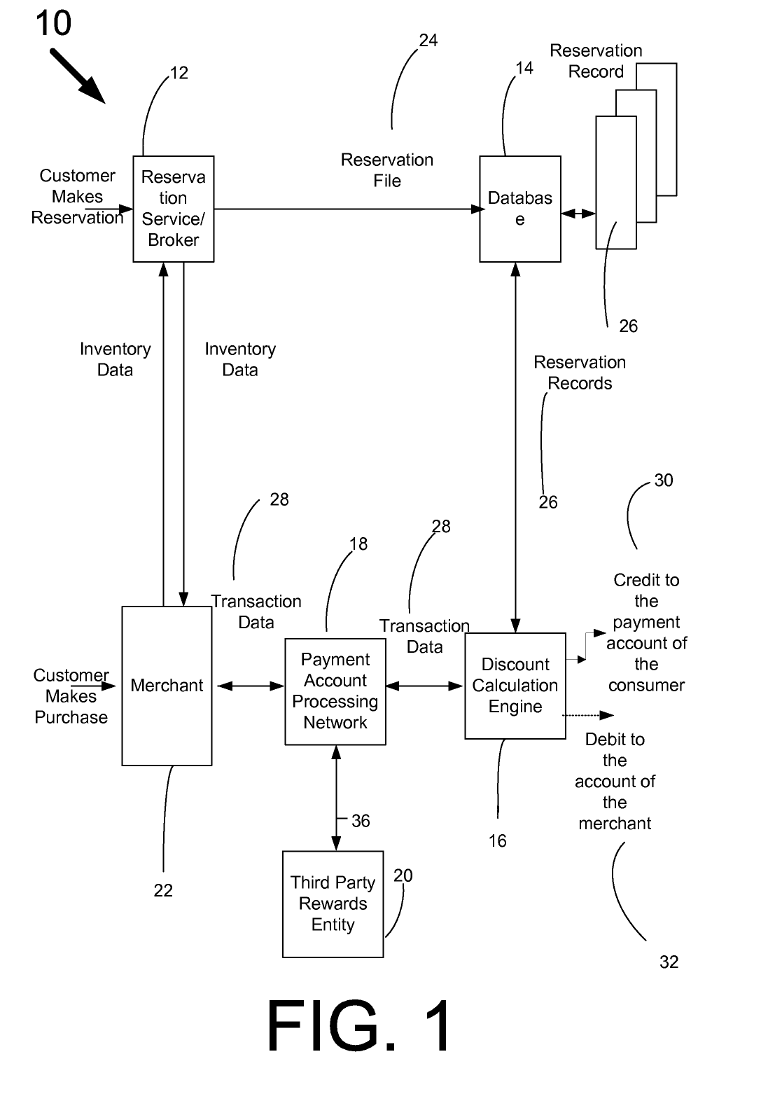

FIG. 1 illustrates an example of a block diagram for providing automated discounts for purchases from the merchants using a system 10, in accordance with one implementation. In FIG. 1, the system 10 may include a reservation service/broker 12, a database 14, and a discount calculation engine 16.

The reservation broker 12 is, in one example, in communications with the database 14, which is in communications with the discount calculation engine 16. The discount calculation engine 16 is in communications with (or may be integrated into) the payment account processing network 18, which may be in communications with third party reward entities 20, if desired, such as airline mileage providers, hotel point providers, and other conventional awards or rewards providers. The database 14 and discount calculation engine 16 may be integrated together into a computing system and may be co-located or geographically separated if desired.

The functions denoted by the reservation broker 12, database 14, discount calculation engine 16, and the payment account processing network 18 may be conducted by entities within a payment processing system. See infra section The Payment Processing System. For example any of: an issuer, an acquirer, or a transaction handler (e.g., a credit card company) may provide the functions of the reservation broker 12, database 14, discount calculation engine 16, and the payment account processing network 18.

The reservation broker 12 may be implemented as a website, telephone service, or other service. For example, the consumer such as a cardholder may contact the reservation broker 12 to make a reservation the merchant 22 that may be the participating merchant. The merchant 22, such as providers of goods or services, communicate with the reservation broker 12 to establish relationships and define availabilities. For example, a restaurant may establish a relationship with a reservation broker 12 wherein the restaurant provides two reserved tables each day throughout the hours of operation of the restaurant for reservations through the reservation broker 12. The reservation broker 12 may provide an automated computer interface which provides available reservations to the consumer, and upon the consumer making a reservation, communicates the reservation information to the merchant 22.

In accordance with one implementation, the reservation file 24 is sent by the reservation broker 12 to the database 14 for use by the discount calculation engine 16. In one example, the reservation file 24 includes a cardholder information (e.g., a payment card number, the payment account number, or a consumer name), data about the merchant 22 (e.g., a profile of the merchant 22, a category code of the merchant 22, a name of the merchant 22, a zip code of the merchant 22, a unique identifier of the merchant 22), reservation information (e.g., date of reservation, time of reservation, an inventory category), or discount information (e.g., discount percentage for this reservation, redeemable reward).

The reservation file 24 may be transmitted by the reservation broker 12 to the database 14 in any conventional manner, including over wired or wireless networks capable of transmitting and receiving encrypted data. The reservation file 24 information may be transmitted in real time or may be batch processed, batch transmitted, may be pushed to the database 14 or pulled from the reservation broker 12, or may be transmitted in any other conventional manner.

The database 14 may be implemented using any conventional database technology. In one example, the database 14 receives the reservation file 24 information from the reservation broker 12, and forms one or more reservation records 26 which may include the data obtained from the reservation file 24. Each reservation record 26 may correspond uniquely to a reservation contained in a reservation file 24. The reservation record 26 may include data from the reservation file 24 such as the time and date of the reservation, the name of a cardholder, card/payment account number, a merchant name, a zip code, and a discount percentage. The reservation record 26 may also contain one or more fields such as a transaction amount, actual calculated discount amount, or date/time stamp of the transaction. Initially, these fields may be null when the reservation record 26 is created at the database 14, and these null fields can be filled with data obtained by the calculation engine after a corresponding credit/debit/payment account transaction has been completed.

In one example, the reservation record 26 is either open or closed, and this status can be set and read by any conventional data processing technique. For instance, if the above described fields are null, then the reservation record 26 can be considered open; and when the above described fields contain non-null values, then the reservation record 26 may be considered closed. Other methods can be used to indicate whether the reservation record 26 is open or closed, such as through bits, flags, data encoding or other conventional techniques.

In one implementation, the database 14 checks to ensure that no duplicate transactions or duplicate of the reservation record 26 exist therein, and if so, the duplicate entries are deleted.

In another example, a validation can be performed to check data within the reservation file 24 against program participants and eligible members to ensure that valid payment accounts are being provided with the discounts or awards. These reservation record 26 may then be transmitted to or otherwise made available to be read or accessed by the discount calculation engine 16.

The discount calculation engine 16 automatically calculates the discount owed to the consumer, and may be implemented as a process, logic, or rules within a computing or electronic device. When the consumer/cardholder utilizes the reservation and transacts business with the merchant 22 using the payment account that is eligible of the consumer, then transaction data 28 is generated and made available to the discount calculation engine 16. The discount calculation engine 16 receives or has access to the reservation record 26 stored by the database 14, and compares data from the reservation record 26 from the database 14 to the payment account transaction data 28, in order to determine the appropriate discount to issue to the consumer and the amount to debit an account of the merchant 22.

In one example, the calculation engine 16 compares the reservation record 26 that are open (e.g., records that have not yet been matched up with an actual transaction) with the transaction data 28. For instance, the transaction data 28 may be provided from the merchant 22 via the payment processing system involving issuers and acquirers. The payment processing system may generate authorization or clearing transaction records, as is well known in the art, including data such as at least one payment account number, authorization amounts, merchant category codes, merchant names/zip codes, payment account authorization dates, etc.

If the discount calculation engine 16 is able to match a reservation record 26 stored in the database 14 against the transaction data 28 such as a transaction record/authorization record from the payment account processing network 18, then a discount amount can be calculated. Assuming that the discount will be provided as a percentage of the charged amount, the discount calculation may include a determination of the lesser of the authorization amount or the clearing amount. The actual discount may be calculated as the product of the discount percentage multiplied by the lesser of the authorization amount or clearing amount. In one example, upon calculating the discount, a credit 30 to the payment account of the consumer is created and applied to the payment account of the cardholder. For instance, the payment account statement of the consumer (e.g., John Smith's payment account) may include language such as “Dining Discount from ACME Steakhouse on Feb. 14, 2005: $12.37” based on the calculated discount amount.

The discount calculation engine 16 may also create a debit 32 to the account of the merchant which is applied to the account of the merchant 22. For instance, the transaction may appear on the account statement of the merchant 22 as “Dining Discount on Feb. 14, 2005 for John Smith: $12.37.” Where the consumer has requested that the discount be credited to the consumer in the form of rewards such as airline miles, points, or other currency, the merchant 22 may be debited the actual dollar amount of the discount, and that amount is translated into the requested reward for the consumer.

The discount calculation engine 16 may also populate the data fields of the reservation record 26 so that the record is no longer an open record. For instance, the data field may be populated with: the transaction amount, an actual calculated discount amount, and a date/time stamp, or the data obtained by the discount calculation engine 16 so that these reservation record are no longer considered open.

The database 14 and the discount calculation engine 16 may be integrated together into a computing system and may be co-located or geographically separated if desired. The database 14 and discount calculation engine 16 may be integrated and operated by a single entity. For instance, the payment processing system or a bank could offer the services of automated discount calculations by integrating one or more features of the discount calculation engine 16 and database 14.

While the payment account processing network 18 is shown in communications with the third party rewards entities 20 in order to provide points, miles, or other awards to the consumer, it is understood that the third party rewards entities 20, in another example, may be in communication with the discount calculation engine 16, and in this example, the discount calculation engine 16 could communicate with the third party entities 20 in order to generate a reward credit to the consumer based on and in proportion to the discount calculated by the discount calculation engine 16.

The discounts calculated by the discount calculation engine 16 may be credited to the payment account of the consumer in whatever form a particular payment account company or banks support within its network. For instance, if the payment account company or banks provide for cash back dollars, airline mileage, points, or other awards or rewards, then the particular reward can be credited to the payment account of the consumer without the need for communication with a third party rewards entity 20. However, to the extent that the payment account company or banks support or promote the rewards of the third party rewards entity 20, such as hotel points, airline mileage, or other discounts or rewards, through a communication link 36 between the payment account processing network 18 and the third party rewards entities 20, such third party rewards can be issued to the consumer.

Implementations may help the merchant 22 manage inventory including distressed inventory, bucketed inventory, or inventory that has no reservation associated with it. In one example, the merchant 22 may identify when the merchant 22 needs to provide discounts (such as during slower times during the day, or slower days during the week, or slower seasons of the year or other times) in order to entice more business of the consumer or more traffic of at least one of the consumers during such slow time periods. In another example, the merchant 22 can specify different discount amounts that the merchant 22 is willing to offer for different reservation times. For instance, the reservation broker 12 can include a graphical user interface for use by the merchant 22 wherein the merchant 22 can specify the date and times when a particular discount amount will be made available. The reservation broker 12 can then make this information available to the consumers/cardholders so that the consumers are provided with incentives to make reservations during slower times for the merchant 22.

The transaction data 28 associated with a purchase of the inventory of the merchant 22 can be tracked within the system 10. Types of the transaction data 28 that can be tracked and maintained include: payment card number or the payment account number, payment or transaction amount, the residential of the consumer or billing zip code of the consumer; the type of payment card such as a gold card of the consumer; the SKU number for a good purchased; or a unique identifier for the merchant 22. For example, the payment account processing network 18 may track and keep records of whether the transaction associated with a purchase of the inventory of the merchant 22 was eligible for a discount based on the inventory category. If the transaction was eligible for the discount, the payment account processing network 18 may also keep records of the amount of the discount eligible or the amount of the discount applied. Therefore, if a restaurant consumer makes a reservation with one credit card but uses another credit card to pay for the transaction, that information can be tracked. Should the discount be applied because the transaction was eligible for the discount based on the inventory category and the consumer fulfilled the requirements for applying the discount, such as paying with the credit card used to make the reservation, the discount amount can also be recorded.

The discounts may be dynamically adjusted by the merchant 22 through a graphical user interface based on a number of factors, including: the time of reservations; the inventory and its categories, such as indoor versus outdoor seating; deluxe rooms versus standard rooms; or remaining availability of the inventory.

In one example, a prospective discount may be indicated on the initial bill of the merchant 22 to the consumer. Based on data within the reservation file 24 received from the reservation broker 12, the billing system of the merchant 22 may utilize this information in order to communicate to the cardholder/consumer that a discount is available if the consumer utilizes the payment account that is eligible. For instance, the initial bill of the merchant 22 to the consumer may state “If you use your VISA™ card, you are entitled to a 10% discount” or other language.

Implementations may also provide various reporting functions. For instance, totals of the transaction amounts and the discount amounts may be provided, in graphical, numerical, or other conventional forms of reports. Further, trend analysis may be provided, such as for each of the merchants 22 or groups of similar merchants of the merchants 22, showing the discount amounts over specified periods of time, for example.

The system 10 may facilitate the management of more than a selected inventory (potentially including tracking of an entire inventory of the merchant 22). Management of the inventory may include the merchant 22 creating a merchant profile indicating information about the inventory of the merchant 22. For example, the merchant 22 may categorize the inventory of the merchant 22 into various inventory categories, such as indoor or outdoor seating, reservable or non-reservable dining tables, or suite hotel room or base hotel room. The categories may have a discount or a time specific associated to them, such as the inventory category of dining tables eligible for a 5% discount for reservations for Monday dining. Moreover, the inventory category may be consumer specific, such as giving a different discount to consumer that repeatedly purchases the inventory of the merchant 22 versus the consumer that is purchasing the inventory of the merchant 22 for the first time.

Management of the inventory may include the merchant 22 manipulating the inventory category. The payment account processing network 18 may electronically store the merchant profile for the merchant 22 including inventory categories describing the inventory of the merchant 22 in the database 14 that can be a relational database. The merchant 22 may access the merchant profile to change the inventory categories or inventory cataloged thereby. For example, the merchant 22 may have the inventory category of “dining tables that can be reserved for Monday night dining.” Initially, the inventory category of “dining tables that can be reserved for Monday night dining” may have a 10% discount off the dining bill. The merchant 22 can manipulate the inventory category by changing the discount value from 10% to 5% for the holiday season. The merchant 22 can also manipulate the inventory category by moving the inventory from one category to another category. In another example, the merchant 22 might have a premium category, such as outside dining tables that have a certain level of discount associated with the premium category. The merchant 22 may manipulate the inventory category by taking the outside tables out of the premium seat category during the winter season.

The inventory category may or may not have the discount associated with the inventory, but will nonetheless be tracked, reported, and analyzed via the system 10. The information tracked, recorded and analyzed in the system 10 can include: a transaction data 28 associated with the purchased inventory, a reservation file 24 relating to a reservation associated with the inventory, or an indication of any applicable discount. An indication of the discount may include: whether a discount is applicable such as when a match exits between an element (e.g., the payment account number) within the transaction data 28 and an element (e.g., the payment account number) within the reservation file 24, the dollar value of the discount, point value of the discount, or the percentage value of the discount such as 5% or 10%. The data can be kept in a database such as database 14.

The information about the inventory, the transaction data 28, or the result of comparing elements of the reservation file 24 to the transaction data 28 elements may be recorded, such as being recorded in the database 14. For example, the transaction data 28 and an indication of the discount can become part of a reservation record 26 via the discount calculation engine 16. The information in the reservation record 26 can then be recorded in the database 14. Similarly, information in the reservation file 24 can be recorded in database 14. The payment processing system may facilitate the recordation of the information about the inventory, the transaction data 28, the result of comparing elements of the reservation file 24 to the transaction data 28 elements, or the indication of the discount.

An analytical tool can be used to analyze the information tracked and recorded. An analytical tool can include an analytic, static, dynamic, statistic, mining, filtering, analyzing, targeting, coding, or tagging tool. The output of the analytical tools can be included in a report. Such reports can include: trends based on demographics; seasonal changes; type of card used, such as a base card versus a gold card; time lag between making reservation and the time of dining compared to the trend of how often the consumer canceled the reservation; or other trends that may help the merchant 22 better manage its inventory. For example, the merchant 22 may be an airline company evaluating a gold card promotion plan. The airline company may use the data mining tool to analyze the transaction data 28 including information about first class seating sold on the Internet to gold card members.

In another example, the reservation broker 12 provides an enrollment option wherein a new consumer can enroll to utilize the reservation broker 12. The reservation broker 12 may provide graphical user interfaces to set up online user profiles of the consumers, for instance, including but not limited to the consumer/cardholder name, password, payment account types and numbers, or other information regarding the consumer. The reservation broker 12 may provide a graphical user interface which gives the consumer an option to select which type of reward currency the cardholder desires the discount to be provided (e.g., cash back reward, discount, points, mileage, prepaid gift cards, annual payment account fee discounts, or other rewards).

The reservation broker 12 may authenticate the consumer through a username and password, and may provide extra rewards if the particular consumer is a frequent user of the reservation broker 12. The reservation broker 12 may provide the consumer with loyalty points or other rewards for each use of the reservation broker 12, including but not limited to up front or immediate bonus incentives, such as points, miles, discounts, or other incentives.

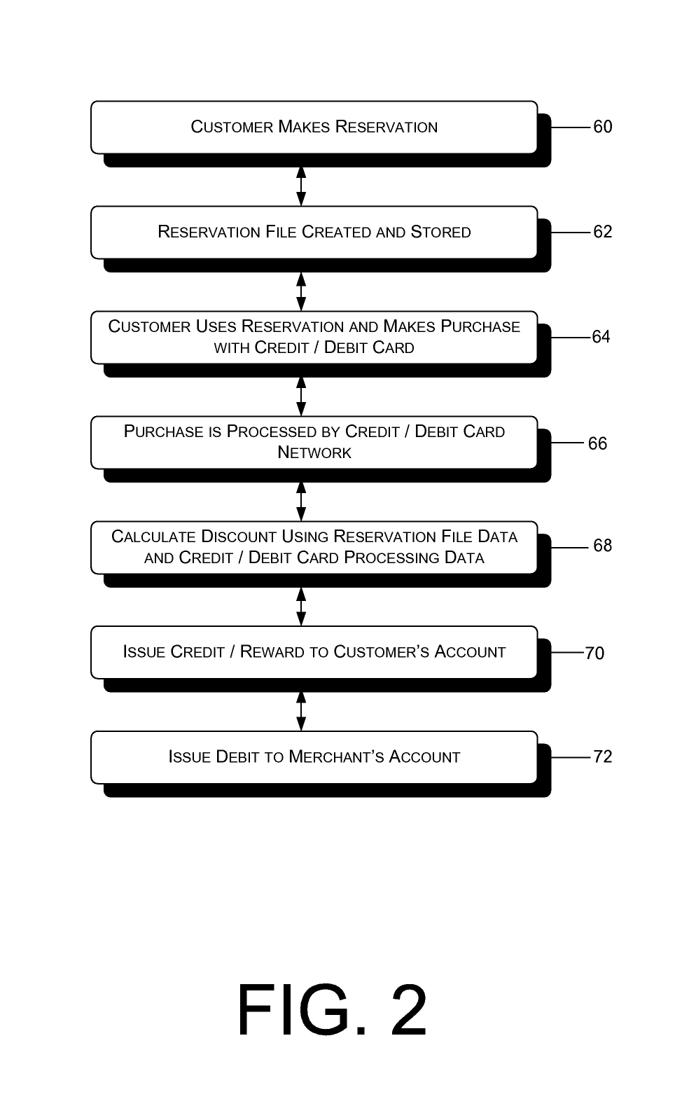

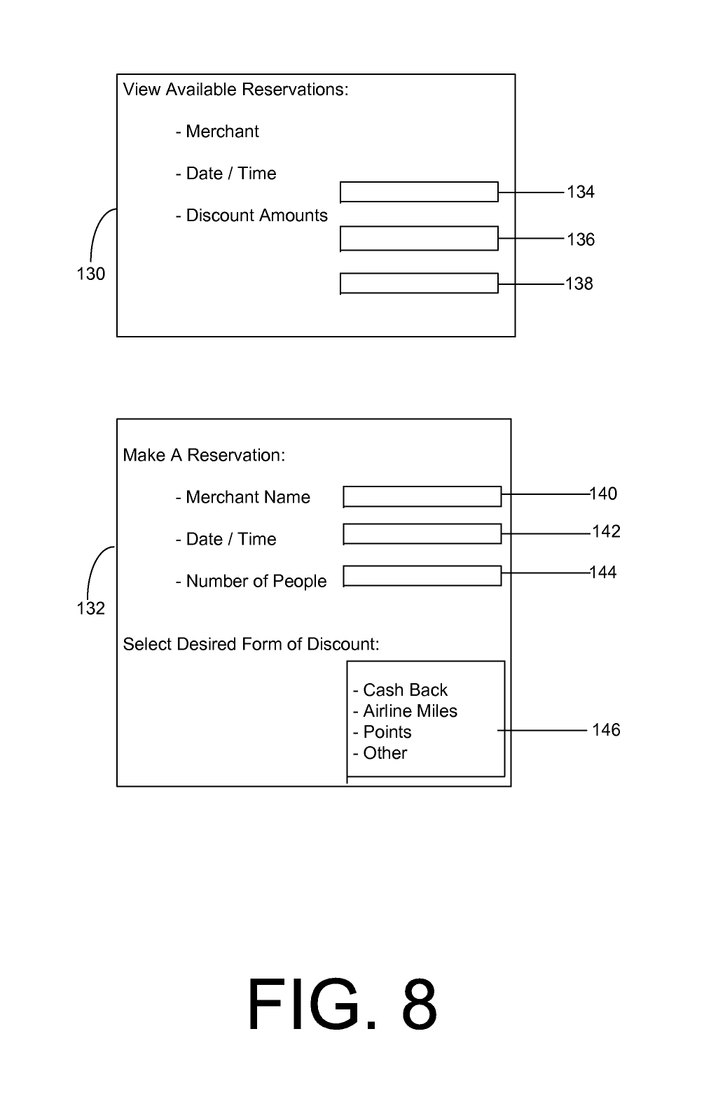

FIG. 2 illustrates an example of logical operations for providing automated discounts or rewards for purchases made from the merchant 22 as part of a reservation program, in accordance with one implementation. At an operation 60, the consumer makes a reservation, preferably using the reservation broker 12. In one example, the reservation broker 12 provides a list of the merchants 22 that the consumer may select from, as well as available reservation dates (and times if appropriate) as well as the amount or percentage of discounts available for the reservation. The data may vary depending upon the type of reservation (such as a restaurant reservation, an airline reservation, a hotel reservation, or other type) the data made available to the consumer by the reservation broker 12. FIG. 8 illustrates one example of a graphical user interface that may be provided for a consumer by the reservation broker 12. The graphical user interface may also provide the consumer with the ability to create a reservation by selecting the merchant 22, a date or time of the reservation, the number of people or the number of units requested for the reservation, or any other piece of data that would be useful in performing the reservation. In accordance with one implementation, the reservation broker 12 may provide the consumer with the ability to specify the desired form of the discount. For instance, the consumer may request the discount in the form of cash back, airline miles, points, or other form of reward, award, or rebate.

The operation 60 may also include obtaining other information regarding the reservation including the name of the consumer and the payment account number of the payment account, the name of the merchant 22, category code of the merchant 22, and zip code of the merchant 22, the discount percentage available for the particular reservation, as well as the reservation time and date.

At an operation 62, the reservation file 24 is created and stored. In one example, the reservation broker 12 creates the reservation file 24 and transmits the reservation file 24 to the database 14, such as shown in FIG. 1. The reservation file 24 may also be transmitted or communicated to the merchant 22, or portions of the reservation file 24 may be transmitted from the reservation broker 12 to the merchant 22. In the event that the merchant 22 has a computing system coupled with a network, portions of the reservation data may be transmitted from the reservation broker 12 to the merchant 22. In a simple implementation, the reservation broker 12 communicates the name of the consumer, reservation data such as date and time and number of people, to the merchant 22 so that the merchant 22 can make the appropriate arrangements to honor the reservation of the consumer.

At an operation 64, the consumer utilizes the reservation in order to conduct business with the merchant 22. In one example, the consumer makes a purchase of the goods or services of the merchant 22 with the payment account eligible to provide discounts to the payment account of the consumer. If the consumer makes the payment with a non-eligible form of payment, then in one example, no discount will be received by the consumer as is explained below (see an operation 68). At an operation 66, the purchase, made with the payment account that is eligible, is processed by a payment account processing network 18. In one implementation, the payment account processing network 18 may include any conventional system or network for processing transactions, such as the payment processing system, or purchases made by payment accounts including but not limited to credit cards, debit cards, prepaid cards, contactless cards, or the like.

In one example, the merchant 22 is provided with a conventional payment account processing device such as a point of service terminal which is connected through a network to the payment account processing network 18. As shown in FIG. 1, the payment account processing network 18 may also include or be in communications with the discount calculation engine 16 and the database 14.

The payment account processing network 18 generates processing data, including the transaction data 28, such as transaction records, authorization records, and clearing records, as is well known in the art. Implementations may utilize one or more of the records or data available from the payment account processing network 18.

At the operation 68, the discount for the purchase made by the consumer is automatically calculated, and preferably uses data from the reservation file 24 of the operation 62 and the credit/debit/payment account processing data of the operation 66. In one example, one or more portions of the reservation file 24 are compared to find a match to one or more portions of the credit/debit/payment account processing data so that the operation 68 can automatically determine the amount of the transaction, and based on the percentage discount or other discount value indicated in the reservation file 24 of the operation 62, the operation 68 can calculate the actual amounts of the discount owed to the consumer based on the actual purchase made from the merchant 22 at the operation 66. If no match exists, then that means that the payment account that is eligible was not used for the purchase and no discount is awarded.

At an operation 70, the credit 30 or reward is issued to the payment account of the consumer. For instance, the reward may include a cash back dollar amount issued to the payment account of the consumer and reflected in a statement of the consumer for the payment account, or the discount may be credited or rewarded to the consumer through other forms of rewards, such as airline miles, points, or any other form of reward, including those issued by third parties such as hotels, airlines, etc.

The determination of the type or form of discount given to the consumer at the operation 70 may be based, in one example, upon the reservation file 24 of the operation 62, including data obtained from the consumer during the reservation process of the operation 60.

At an operation 72, the debit 32 is issued to the account of the merchant 22 in the amount of the discount calculated by the operation 68, in one example. For instance, the discount calculated by the operation 68 may be communicated to a conventional payment account processing network 18 of a credit/debit/payment account of the merchant 22 so that the credit/debit/payment account accounts reflect a debit in the amount of the discount calculated by the operation 68.

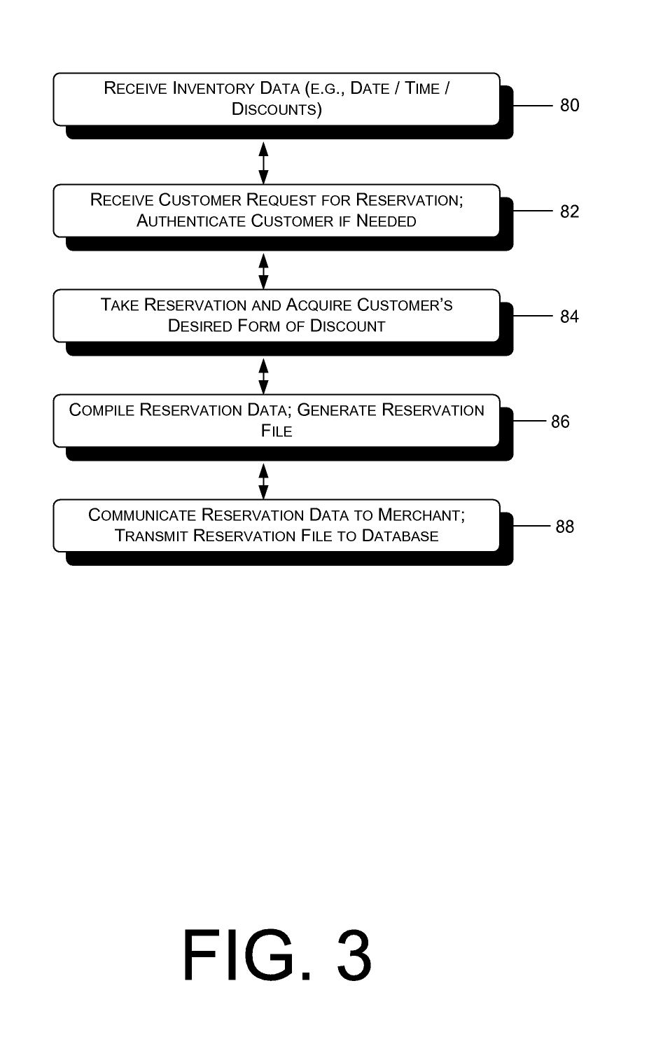

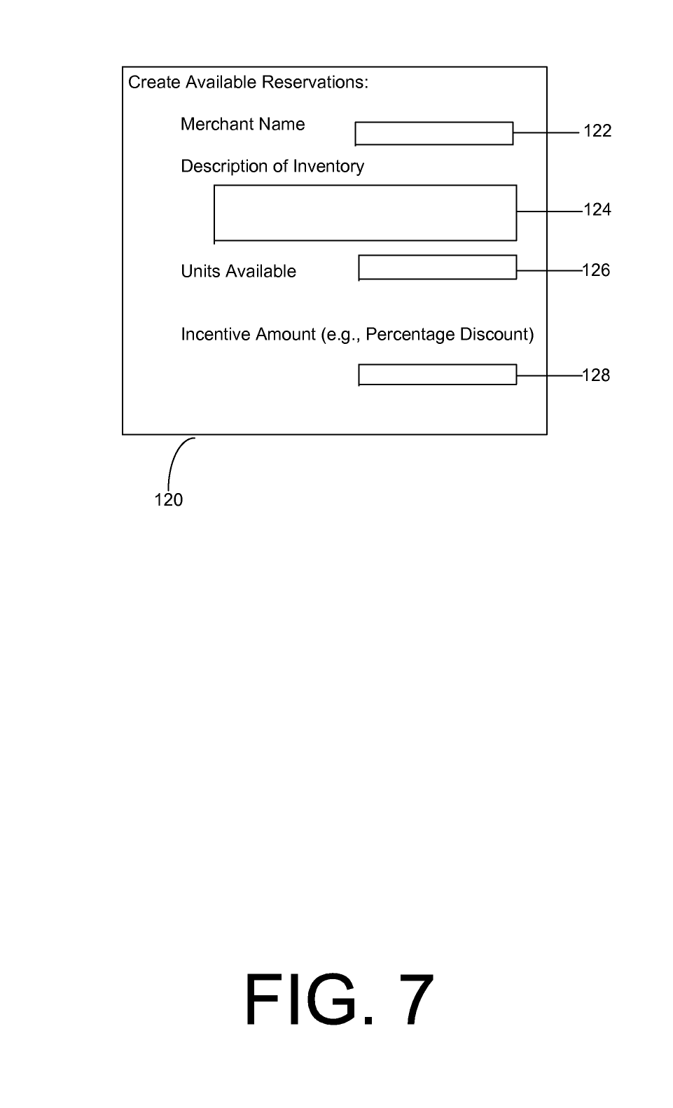

FIG. 3 illustrates an example of operations which may be performed by the reservation broker 12, in accordance with one implementation. At an operation 80, the reservation broker 12 receives inventory data from the merchant 22, including the inventory which the merchant 22 wishes to market through the reservation broker 12 as the inventory that the discount/incentive can be applied toward. In this regard, inventory may include goods or services which the merchant 22 provides, including, for example, but not limited to, airline seats, restaurant reservation seating and time slots, hotel rooms, rental car reservations, or other goods or services. FIG. 7, described below, illustrates an example of a graphical user interface that a reservation broker 12 may provide for the merchant 22 to specify and describe the inventory which the merchant 22 desires to post through the reservation broker 12 for the discounted amount. Preferably, the discount offered by the merchant 22 is available if the consumer pays for the goods or services using the payment account that is eligible.

At an operation 82, the reservation broker 12 receives consumer requests for reservations. In one example, operation 82 may include the reservation broker 12 posting or communicating to the consumers available reservations, goods, or services. The operation 82 may also include authenticating the consumer if needed. For instance, the consumer may establish a payment account profile with the reservation broker 12 including a username and password. Profiles of the consumer may be stored and managed by the reservation broker 12, and may include, in one example, information such as a name of the consumer, address of the consumer, contact information such as cellular phone numbers of the consumer, payment account types and/or partial or full payment account numbers of the consumer, etc. If desired, the reservation broker 12 may track the frequency of use by the consumer of the reservation broker 12, and may provide, as a separate incentive or award, points, miles, or other incentives for frequent use of the reservation broker 12.

At an operation 84, the reservation broker 12 accepts the reservation by the consumer and acquires the desired form of discount of the consumer. Data gathered by the operation 84 may include the name of the consumer, the date and time of the reservation, the amounts or percentage of discount which will be provided, the name of the merchant 22, as well as the desired form of discount of the consumer (e.g., cash back, airline miles, points, or other form of reward or discount). At an operation 86, the reservation data obtained by the operations 82-84 is compiled and the reservation file 24 is generated. In one example, the reservation file 24 includes the payment account information (e.g., payment card number or payment account number), the name of the consumer, a name of the merchant 22, zip code of the merchant 22, and category code of the merchant 22, percentage discount for the reservation, or the reservation date.

At an operation 88, the reservation file 24 is communicated to the merchant 22, and the reservation file 24 is transmitted to the database 14. By communicating the reservation file 24, or portions thereof, to the merchant 22, the reservation broker 12 secures the reservation with the merchant 22 on behalf of the consumer. Additionally, the operation 88 transmits the reservation file 24 to the database 14 for processing by the discount calculation engine 16, described below.

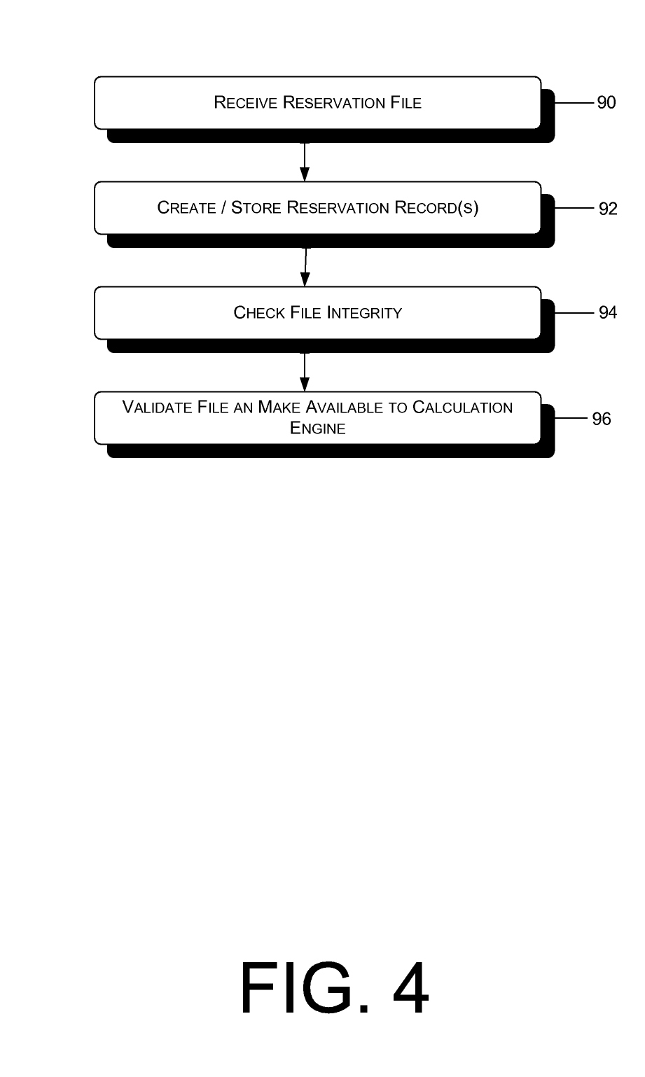

FIG. 4 illustrates an example of operations that may be performed at the database 14 in order to provide automated discount calculations, in accordance with one implementation. At an operation 90, the reservation file 24 is received, and at the operation 92, the corresponding reservation record 26 is created and stored at the database 14. An operation 94 may check the integrity of the reservation file 24, such as through conventional means using check sums or other file integrity checks, and an operation 96 validates the reservation file 24 and makes the reservation file 24 available to the discount calculation engine 16. In one example, the operation 96 includes determining whether a duplicate or substantially similar reservation record 26 exists, and if so, operation 96 can delete the unneeded reservation record 26 as needed.

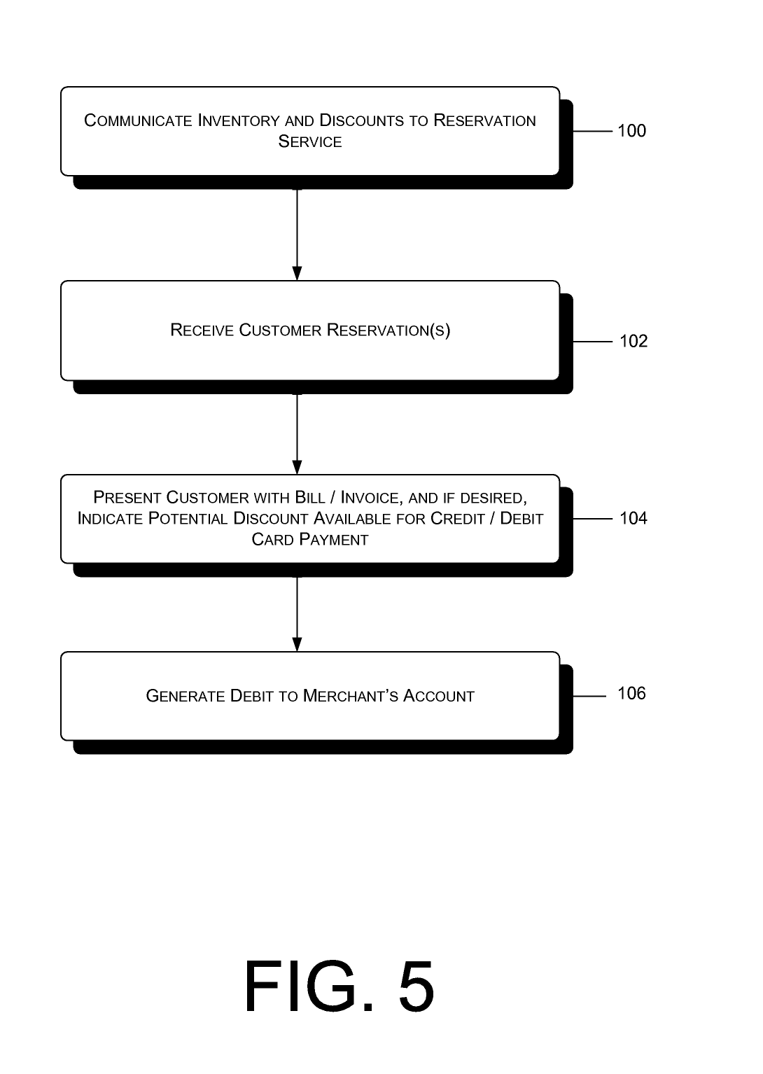

FIG. 5 illustrates an example of operations that may be performed by the merchant 22 in order to provide automated discount calculations, in accordance with one implementation. At an operation 100, the merchant 22 communicates inventory and discounts to the reservation broker 12. For instance, the merchant 22 may communicate information telephonically, by facsimile, or via a graphical user interface, such as may be provided by the reservation service.

FIG. 7, described below, illustrates an example of a graphical user interface (GUI) which the reservation broker 12 may provide in order to obtain information from the merchant 22. As mentioned above, the inventory of the merchant 22 may include products or services which the merchant 22 wishes to make available and market through the reservation service. These products or services may include, but are not limited to, hotel reservations, restaurant reservations, airline reservations, rental car reservations, or other goods or services. In one example of the operation 100, the merchant 22 provides varying discounts of its goods or services based upon the desire of the merchant 22 to motivate consumers to purchase such goods or services. For instance, a restaurant may provide a 25% dining discount for reservations made on Monday afternoon from the times of 5 P.M. to 6 P.M., and provide a 10% dining discount for reservations made for Saturday night between 7 P.M. and 8 P.M. In this example, the merchant 22 provides a deeper discount for the Monday early evening dinner reservation in order to generate business during this otherwise slow time.

At an operation 102, the merchant 22 receives consumer reservations. When the consumer arrives and purchases goods or services, then at an operation 104 the merchant 22 presents the consumer with the bill or invoice. In one example, the merchant 22 may generate a bill which indicates that a discount is available (e.g., a prospective discount) if the consumer utilizes the payment account that is eligible for payment of the bill/invoice. This indication may act as a reminder to the consumer that, in order to receive the discounts indicated by the reservation broker 12 when the consumer made the reservation, the consumer may pay using the appropriately payment account that is eligible. It is understood, however, that indication of the potential discount of the operation 104 is optional and may be included or omitted by the merchant 22, depending upon the particular implementation.

At an operation 106, the merchant 22 processes the purchase of the consumer with the payment account of the consumer. The operation 106 may be performed using any conventional payment account processing system.

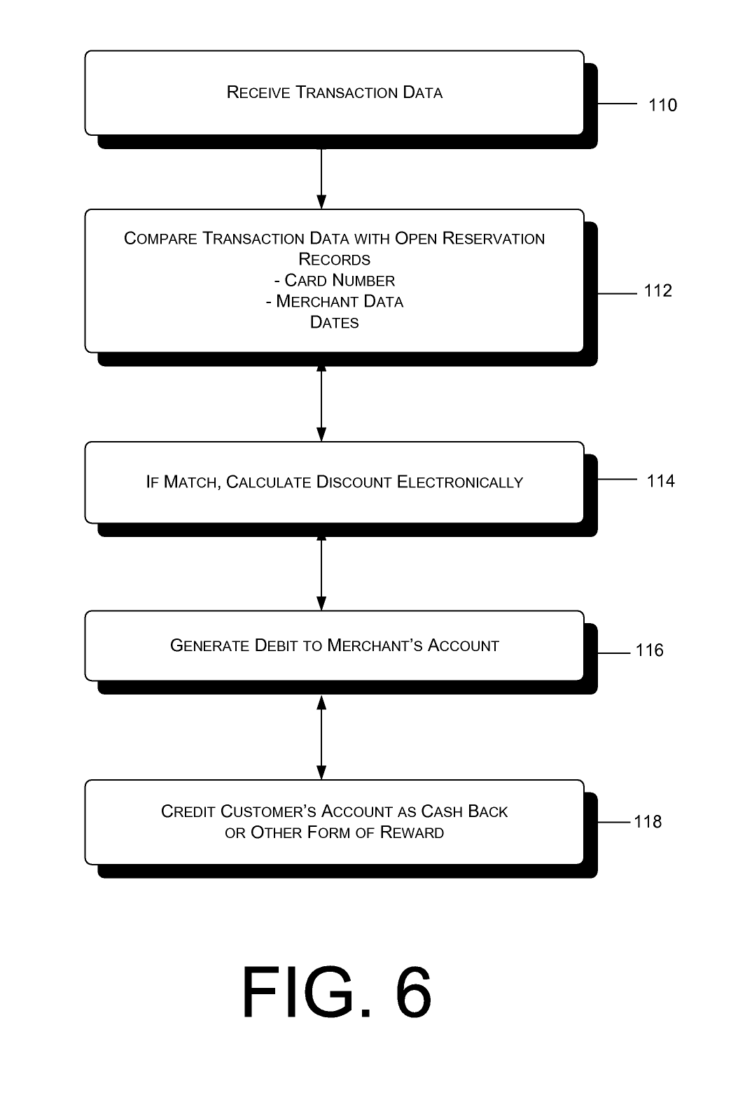

FIG. 6 illustrates an example of operations which may be performed by the discount calculation engine 16 in order to automatically calculate discounts or rewards for purchases made, in accordance with one implementation. At an operation 110, the discount calculation engine 16 receives or has access to the transaction data 28, preferably from the payment account processing network 18. As described above, the transaction data 28 may include authorization data, clearing data, or transaction records or other information provided by the payment account processing network 18. At an operation 112, the calculation engine may compare the transaction data 28 received at the operation 110 with the reservation record 26 that are open and are made available in the database 14. The operation 112 seeks to find a match between one or more portions of the transaction data 28 and the appropriate reservation record 26 that is open. In one example, the operation 112 compares the payment account number or payment account numbers, transaction date, and data of the merchant 22 (e.g., a category of the merchant 22, the name of the merchant 22, or a zip code of the merchant 22) of a transaction to the corresponding data fields of the reservation record 26 that is open in order to find a match. Other comparisons can be used as well for the purpose of finding a match between a reservation record 26 and the payment account that is an eligible transaction, depending upon the particular implementation.

If no match is found, no discount is calculated or rewarded. If a match is found, an operation 114 calculates the discount electronically. In a simple example, the operation 114 calculates the actual discount as the discount percentage (contained within the reservation record 26) multiplied by the transaction amount (obtained from the transaction data 28). Hence, the actual discount dollar value has been calculated.

In situations where the transaction data 28 includes an authorization amount as well as a clearing amount, the operation 114 may also include a determination of the lesser of the authorization amounts or clearing amount, and the actual discount dollar amount may be based upon the lesser of the authorization amount or the clearing amount, in one example.

Having calculated electronically the discount amount, operations 116-118 generate the appropriate credits and debits to the payment accounts of the consumer and the accounts of the merchant 22, respectively. These credits and debits can be effectuated utilizing conventional credit/debit/payment account processing techniques, for instance, an operation 116 can generate a debit to the account of the merchant 22 in the amount calculated by the operation 114. An operation 118 generates credits to the payment account of the consumer in the amount of the discount calculated by the operation 114. In one example, the payment account of the consumer is credited, or in another example, the consumer is rewarded with other forms of rewards such as airline miles, points, or other rewards or incentives, for instance as specified by the requests of the consumer as acquired by the operation 84 of FIG. 3. The operation 118 may communicate a dollar amount to a third party reward entity, and the third party reward entity may calculate the appropriate amount of reward which will be provided to the consumer in exchange for the dollar amount. Or, if desired, the discount calculation engine may include one or more modules for converting the discount calculated by the operation 114 into the appropriate or proportional amounts of airline miles, points, or other rewards that the consumer desires.

In one example, because the operation 118 may generate a credit to the payment account of the consumer in the amount of the discount, such a credit may be reflected upon a statement of the payment account of the consumer as an award or cash back for purchasing goods or services from the merchant 22 using the reservation service.

FIGS. 7-8 illustrate examples of graphical user interfaces that may be provided by a reservation service, in accordance with one implementation. It is understood that these FIGS. 7-8 are provided as examples and that various implementations may or may not include one or more features shown therein. In FIG. 7, the GUI 120 may be provided for the merchant 22 to create or post reservations. In one example, a display screen of GUI 120 may include a field 122 for specifying or displaying the merchant 22 name, and may also include a field for the merchant 22 to describe the inventory being made available for reservation or use to consumers. A field 126 may be provided for the merchant 22 to specify the number of units available. A field 128 may be provided for permitting the merchant 22 to specify the incentive amount, such as a percentage discount. Other fields may be provided as well depending upon the implementation, including but not limited to, date and time fields.

Using the GUI 120, the merchant 22 can create or post a number of goods or services available for reservation or use by consumers through the reservation service. Preferably, the discount indicated in the field 128 is available to the consumer if the consumer uses the payment account that is eligible.

FIG. 8 illustrates two examples of GUI: a GUI 130, and a GUI 132 for use by consumers in making reservations through the reservation service. Sample display screen of the GUI 130 may include a display of available reservations, which may include a section 134 for displaying the merchant 22 participating in the reservation service, a section 136 for displaying the dates/times of available reservations, and a section 138 for indicating the discount amounts available for the particular open reservations. It is understood that other display fields may be included, for instance, fields describing the goods or services available for reservation use or by the merchant 22.

Example display screen of the GUI 132 can be utilized to provide a consumer with the ability to make or book a reservation. The display screen of the GUI 132 may include a field 140 for the consumer to specify a particular merchant such as the merchant 22 with which the consumer wishes to make a reservation; a section 142 for the consumer to specify a date/time for a reservation; and a section 144 for a consumer to specify the number of people or number of units involved in the reservation. A section or a field 146 may be provided, such as a dropdown menu, which permits the consumer to select the desired form of the discount, such as cash back, airline miles, points, or other rewards.

In another implementation, a discount value proposition sales method may be used in which the merchant 22 is held to a discount off of the net bill (excluding tax, tip, etc.) while the cardholder is given a lower discount off the gross bill (including tax and tip, etc.). For instance, an implementation could be formed where the merchant 22 could pay the discount in the form of 20% off the net bill, and cardholders could be charged 15% of the gross bill, so that the merchant 22 actually pay the full 20% discount a fraction of the time. Alone or in combination with other features described herein, this formulation may be beneficial in marketing an automated discount program to the merchant 22.

In another implementation, automated discounts or incentives may be offered by the merchant 22 as standing discounts that are automatically available to the payment account that is eligible, such as the payment account that had previously been enrolled with the reservation broker 12. The standing discounts can be applicable to certain days of the week or month, times within a day, or may apply all days or all times if desired. For example, all payment accounts of Chase™ Disney™ cards can be enrolled for a family dining program that would give 25% off at certain restaurants on Mondays and Tuesdays, and the automated discounts could be provided by the payment account processing network 18 and/or statement credits.

In this example, the payment processing system could match transactions from the merchant 22 to the payment account that had previously been enrolled with the reservation broker 12. This would allow the merchant 22 to offer any specific payment account-type to receive certain discounts based on enrollment with no tie to a specific personalized reservation or without effort/expense of the merchant 22 to grant access to any additional third parties to see payment account transactions in order to operate an enrolled card program.

Accordingly, it can be seen that implementations provide for the automatic calculation of discounts or rewards for purchases made by a consumer from the merchant 22 as part of a reservation program.

It is understood that one or more of the operations shown in FIGS. 2-6, as well as one or more of the portions of the graphical user interfaces of FIGS. 7-8, may be utilized in a system such as but not limited to the system of FIG. 1. It is also understood that one or more of the operations of FIGS. 2-6 or one or more of the features of FIGS. 7-8 may be incorporated into a system for providing automated discounts or rewards, wherein such system is different than the system of FIG. 1.

Through the automation of the calculation and awarding of discounts or other awards, the risk of human error (such as errors that may be introduced by the merchant 22 during the calculation of discounts) is significantly reduced. Moreover, the time used by the merchant 22 to process a transaction is reduced, since the burden of calculating the actual discount is automatically performed by the discount calculation engine 16 as opposed to the merchant 22, thereby improving the efficiency of the merchant 22 of transaction processing and overall satisfaction of the consumers.

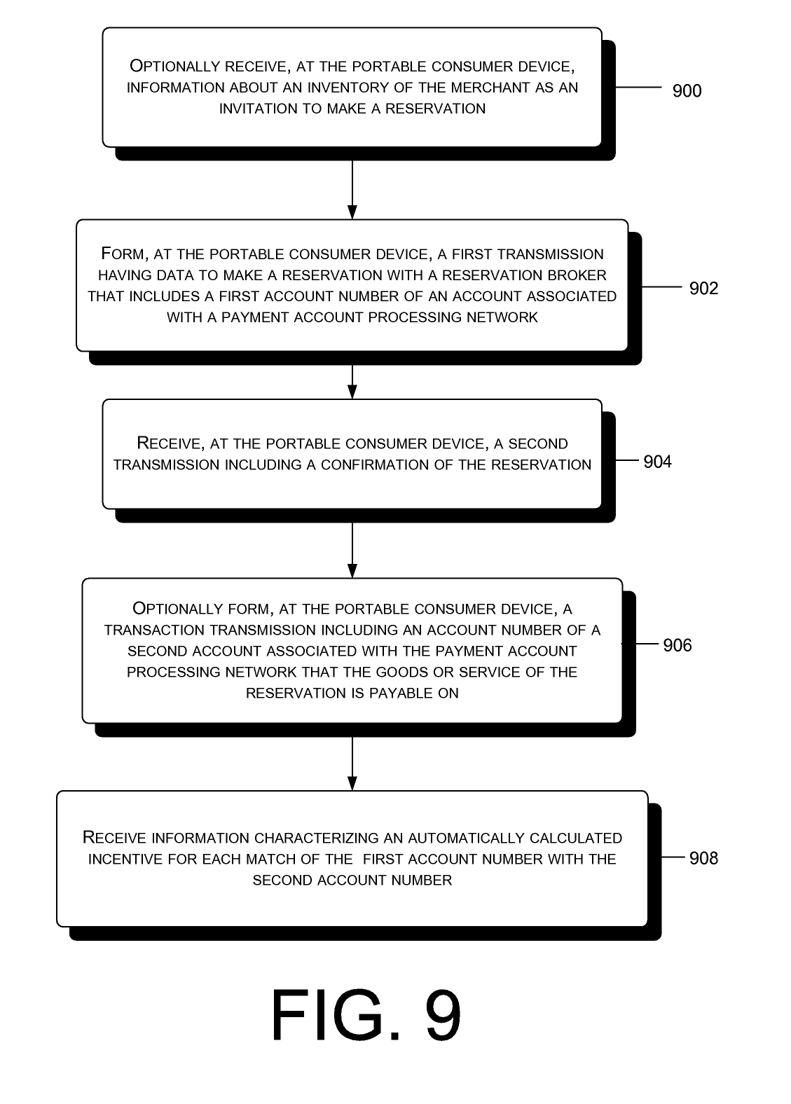

Referring to FIG. 9, a method for receiving an incentive is illustrated. The consumer, can communicate with the reservation broker 12 utilizing the portable consumer device to make a reservation, such as a dinner reservation. The communication may be a transmission including the payment account number of the payment account associated with the payment processing system. Thereafter, if the consumer utilizes the same payment account number to pay for the goods or service the consumer reserved, the consumer may receive the incentive. The portable consumer device may include a hand held telecommunication device, a cellular telephone, a hand held computer, a personal digital assistant, a pager, a smart media device, a transponder, a laptop personal computer, a virtual cash register, and a combination thereof.

At step 900, the consumer may optionally receive, at the portable consumer device, such as the hand held consumer wireless telecommunications device, information about the inventory of goods and/or services of the merchant 22 as an invitation to make a reservation. The information may be sent to the portable consumer device to entice the consumer to make a reservation and pay for the inventory of the merchant 22. For example, the information may include information about the incentive that the consumer may become eligible for if the consumer satisfies the conditions for the incentive such as “make a reservation for a Celine Dion concert using your Caesars Palace® credit card and pay for the ticket with the same card to receive a free upgrade in your seating area.”

The consumer may have enrolled with the reservation broker 12 to receive information about the inventory of goods and/or services of the merchant 22. The consumer may have enrolled by creating a profile with the reservation broker 12 or with the payment processing system. Creating the profile may include entering into a database information such as: a name of the consumer; indicators of the payment accounts (e.g., the payment account number) of the consumer within the payment processing system; preferences for receiving information regarding the inventory of the merchant 22; preferences for the value of the incentive (e.g., ten percent off); or form of the incentive such as a designation directing the incentive to be applied as a credit to the first payment account or directing the incentive to be a U.S. Airways® bonus miles incentive applied to a frequent flier account; forms of advertisement that the consumer would like information on, such as information on restaurants or concert ticket distributors; purchasing preferences of the consumer such as vacation travel destinations; or a combination of the foregoing. For example, the consumer may wish to create a profile such that a credit is applied toward the payment account of the consumer identified in the profile each time the payment account is used to make a reservation and pay for a dinning service at a restaurant.

At step 902, a transmission having data to make a reservation with the reservation broker 12 is formed. The transmission can be sent to the reservation broker 12. The data in the transmission can include an indicator of a first payment account associated with the payment processing system such as the payment account number for a credit card account. For example, the consumer may utilize the portable consumer device to create a transmission to reserve seats for the Celine Dion concert using the Caesar Palace® credit card of the consumer.

Other data that may be included in the transmission to make a reservation may include: the name of the consumer; a username for the consumer; a password for the consumer; a type of payment device associated with the payment account of the consumer, such as a gift card or prepaid card; a selected form of the incentive (e.g., free upgrade or cash back); the amount of the incentive, for example, the consumer may expect ten dollars cash back ($10 U.S.) when making the reservation and paying for the inventory of the merchant 22 using a gift card; the percentage of the discount such as a ten percent (10%) discount on the total purchase price; a date of the reservation; a time of the reservation; a code for the merchant 22 having inventory corresponding to the reservation, such as the a company name of the merchant 22; a category code for the merchant 22 having inventory corresponding to the reservation, such as “CONET” representing the merchant 22 that has inventory corresponding to a concert entertainment category code; a description of inventory corresponding to the reservation, such as a concert ticket number; the number in a party corresponding to the reservation; or a combination of the foregoing. For example, the consumer may use a cell phone to form a transmission for a dinner reservation for a party of four at a Four Seasons® restaurant on December 24 using a Four Seasons® gift card.

The transmission may include a number of transmissions during an interactive session wherein the data for the reservation is compiled. For example, the consumer may use the hand held wireless telecommunication to log onto to a website of the reservation broker 12 having the display screen of the GUI 132 during an on-line, real-time interactive session. The consumer may enter information into the field 140 within the display screen, use pull down menus, or hyperlink between reservation choices to make the reservation. The consumer may send several successive transmissions during the interactive session.

Alternatively, the transmission to make a reservation may be a single transmission. For example, the consumer may enter the data for the reservation into the hand held wireless telecommunication offline and send all of the data to the reservation broker 12 in one transmission online. The consumer may have a form for making reservations with the reservation broker 12 that can be filled with the data and then sent to the reservation broker 12.

The transmission may include a request to enroll the first payment account in a standing reservation program such that the first payment account is associated with a sequence of reservations. For example, the consumer may be an avid diner at the Four Seasons® restaurant. The consumer may wish to make a standing reservation using the credit card of the consumer such that the consumer has a table reservation for every Friday night. The consumer may enroll the credit card account to receive, with each paid dinner associated with the standing reservation program, a corresponding incentive, such as bonus miles.

At step 904, the consumer may receive a confirmation of the reservation. For example, the consumer may receive a transmission on the portable consumer device of the consumer including a confirmation that the first payment account is eligible to be used to make the reservation with the reservation broker 12 and that the dinner reservation for four at the Four Seasons® restaurant on December 24 has been made in the name of the consumer. Moreover, the confirmation may include information on how to consummate the reservation such as by picking up and paying for the Celine Dion tickets at a ticket window of the concert hall on the day of the concert. If the reservation has a preexisting time limit, such as the duration of time the reservation will be honored, the lapse of which will result in a canceled reservation, the time limit may be included in the confirmation transmission.

At step 906, the consumer may use the portable consumer device to pay for the good or service with the second payment account. For example, the consumer may log on to a website of the Four Seasons® restaurant and pay an on-line bill with the Four Seasons® gift card or form a transmission to the payment processing system including: the Four Seasons® gift card number, an indicator of the merchant 22 (e.g., a code for the Four Seasons in Scottsdale Ariz.), the value of the bill for the December 24 dinner, an identifier for the Four Seasons® gift card, instructions to charge the bill on the Four Seasons® gift card, a description of the inventory received (e.g., “dinner at the Four Seasons® restaurant), or a combination of the foregoing. Alternatively, or in combination, the consumer may utilize a wireless communication feature of the portable consumer device, such as an infrared communication means or bluetooth communication means to communicate with a point of service of the merchant 22 to convey the indicator of the second payment account and expiration date of the second payment account of the consumer to pay for the good or service.

At step 908, the consumer may receive information characterizing the incentive if there is match between the first payment account used to make the reservation and the second payment account used to pay for the transaction associated with the reservation. For example, the consumer may receive information at the hand held wireless telecommunication device about the value of the incentive such as “you just received a $10 U.S. credit on your account” or “you have made a reservation for four at a Four Seasons® restaurant using a Four Seasons® gift card, if you also pay for the dinner with the Four Seasons® gift card you will receive $40 U.S. off your dinner bill.” Therefore, the consumer may receive a notice at the portable consumer device that the consumer has satisfied the conditions of the incentive or the consumer may receive a notice at the portable consumer device that the consumer may receive the incentive if the condition is satisfied.

A match exists between the first payment account and the second payment account if they are the same payment account. An algorithm may be used to determine if the first and second payment accounts are the same. For example, an identifier of the payment account can be matched, such as the payment account number for the first payment account may be compared against the payment account number for the second payment account—if the payment account numbers are the same then the first payment account is the same as the second payment account.

A match can exist between the first payment account and the second payment account even if each of the first payment account and the second payment account have different identifiers. For example, a joint payment account may have corresponding respective payment account numbers associated with each of two joint payment account holders. The algorithm can access a database linking each of the corresponding respective payment account numbers to the joint payment account. To illustrate, a wife may make a reservation for a table at the Four Season's® Restaurant with the joint payment account using her joint payment account number “1234567890.” Her husband may pay for the dinner at the Four Season's® Restaurant with the joint payment account using his payment account number “8888888888.” The algorithm may access a database that links both the “1234567890” and the “8888888888” payment account numbers to the same payment account. Consequently, the first payment account is matched with the second payment account and the reward condition is satisfied.

The incentive may be calculated using the algorithm that translates a purchase amount to the value of the incentive. For example, the algorithm may apply a conditional reward logic such as: “if parameter one occurs then parameter two.” Standard conditional reward logic may take the form of: discounts (e.g., “ten (10) percent off a lunch bill if you use the same Nordstrom® credit card you used to make the reservation for the lunch”), rewards, coupons, and spent-and-get promotions. A coupon incentive may be structured such that if the consumer uses the first payment account both to make a reservation and pay for the reserved good or service at the store of the merchant 22 and the value of the purchase exceeds $100 U.S., then 10% will be taken off the purchase value at a point of service (POS) device of the merchant 22. Similarly, the promotion may be a spend-and-get promotion such as when the consumer makes four reservations using the first payment account and conducts four purchases with the second payment account at a store of the merchant 22, the fifth purchase of the consumer at the store of the merchant 22 will result in $10.00 U.S. being credited to the second payment account that was used to pay for the transaction and that matched the first payment account.

The value of the incentive can be based on several factors including the length of time between the receiving of the confirmation of the reservation and the transaction; a date of the transaction (e.g., a holiday session may have a different incentive than a non-holiday session); a time of day of the transaction; a monetary value of the transaction; a number in a party for the reservation; the inventory (e.g., jewelry may have a different incentive than gasoline); or the number of previous reservations that were found to correspond to respective previous transactions for which there was a match, respectively, of the first and second payment accounts (e.g., the consumer that typically makes reservations and pays for the goods reserved with the same payment account may receive a different incentive than the consumer that is a first time user of the reservation broker 12). For example, one factor may be the window of time between making the reservation and the payment for the good and/or service received in association with the reservation (e.g., if the reservation is made within hours of the payment, the value of the incentive may be less).

Alternatively, or in combination, the incentive may use the conditional reward logic that takes into consideration past incentive values. For example, if the consumer has used a Wells Fargo® credit card to make three dinner reservations in the past, paid for the three dinners with the Wells Fargo® credit card, and received $30 U.S. cash back for each of the dinners in the past, the current incentive for a fourth dinner may be $40 U.S. cash back.

Many forms of rewards can be given to the consumer as part of the incentive. For example, money, a frequent traveler program reward, a consumer loyalty program reward, a good, a service, an adjustment to one or more of the transactions payable on the second payment account associated with the payment processing system (e.g., a credit to the payment account), or combinations thereof.

The consumer may also access information about past reservations with the reservation broker 12. For example, the consumer may use the hand held telecommunication device to log on to a computer at the reservation broker 12 having the profile of the consumer. The reservation broker 12 may maintain a reservation history and a payment history of the consumer. The consumer may access the reservation history and payment history to gain information on past reservations and past transactions including: a previously formed reservation; a previously conducted transaction payable on the second payment account corresponding to a previous reservation; a previously received incentive based on a previous match between the first payment account and second payment account; a previous length of time between the previously formed reservation and the previously conducted transaction; a date of previously conducted transaction; a time of day of the previously conducted transaction; a value of the previously conducted transaction; a number in a party for previously formed reservation; the inventory associated with the previously formed reservation; or the incentive associated with the previously formed reservation, for example.

The Payment Processing System

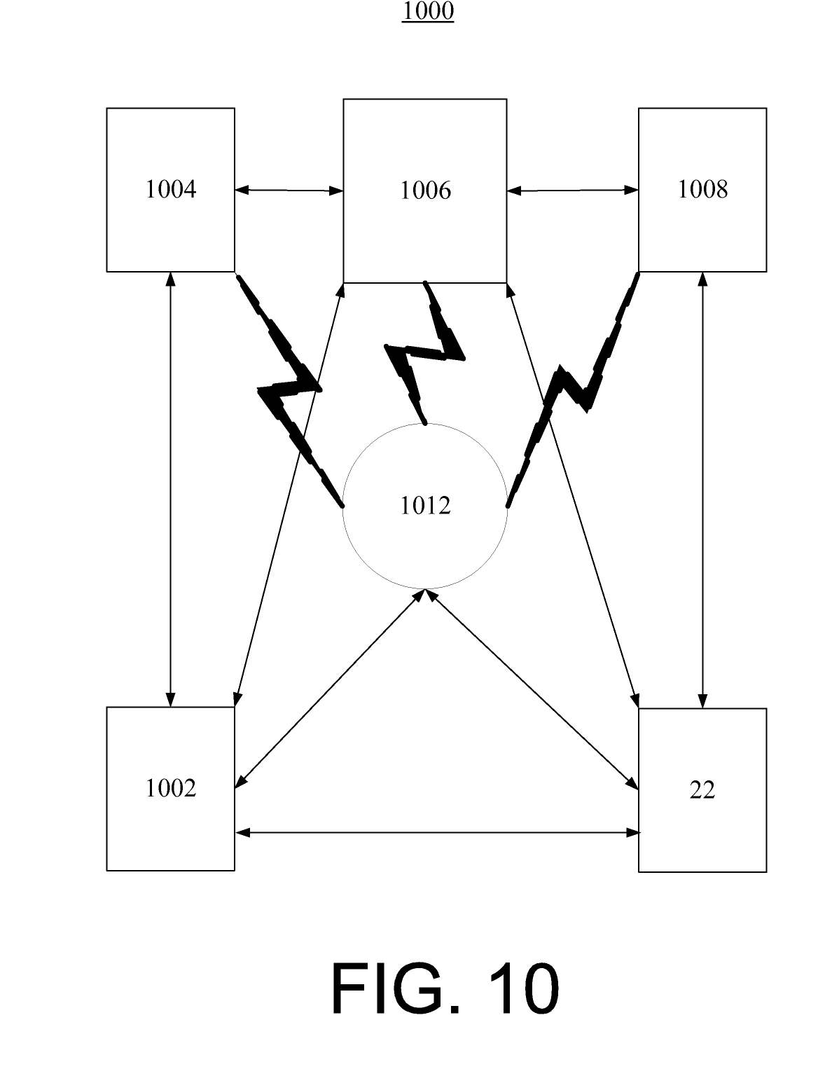

As background information for the foregoing description, as will be readily understood by persons of ordinary skill in payment systems, a transaction such as a payment transaction in a payment system can include participation from different entities that are each a component of the transaction processing system. An exemplary transaction processing system is depicted in FIG. 10 as a payment processing system 1000. The payment processing system 1000 includes an issuer 1004; a transaction handler 1006, such as a credit card company; an acquirer 1008; a merchant 22; and a consumer 1002. The acquirer 1008 and the issuer 1004 can communicate through the transaction handler 1006. The merchant 22 may utilize at least one Point of Service (POS) terminal that can communicate with the acquirer 1008, the transaction handler 1006, or the issuer 1004. Thus, the POS terminal is in operative communication with the payment processing system 1000.

Typically, a transaction begins with the consumer 1002 presenting the payment account number such as through the use of a computer terminal or a portable consumer device 1012 to the merchant 22 to initiate an exchange for a good or service. The consumer 1002 may be an individual or a corporate entity. The consumer 1002 may be the payment account holder of the payment account issued by the issuer 1004 such as a joint payment account holder of the payment account or a person having access to the payment account such as an employee of a corporate entity having access to a corporate payment account. The portable consumer device 1012 may include a payment card, a gift card, a smartcard, a smart media, a payroll card, a health care card, a wrist band, a machine readable medium containing payment account information, a keychain device such as the SPEEDPASS® commercially available from ExxonMobil Corporation or a supermarket discount card, a cellular phone, personal digital assistant, a pager, a security card, a computer, an access card, a wireless terminal, or a transponder. The portable consumer device 1012 may include a volatile or non-volatile memory to store information such as the payment account number or the payment account holder's name.

The merchant 22 may use an acceptance point device, such as a POS terminal, to obtain payment account information, such as the payment account number (e.g., the payment account number of the payment account), from the portable consumer device 1012. The portable consumer device 1012 may interface with the POS terminal using a mechanism including any suitable electrical, magnetic, or optical interfacing system such as a contactless system using radio frequency, a magnetic field recognition system, or a contact system such as a magnetic stripe reader. The POS terminal sends a transaction authorization request to the issuer 1004 of the portable consumer device 1012. Alternatively, or in combination, the portable consumer device 1012 may communicate with the issuer 1004, the transaction handler 1006, or the acquirer 1008.

The issuer 1004 may authorize the transaction using the transaction handler 1006. Authorization includes the issuer 1004, or the transaction handler 1006 on behalf of the issuer 1004, authorizing the transaction in connection with instructions of the issuer 1004, such as through the use of business rules. The business rules could include instructions or guidelines from the transaction handler 1006, the consumer 1002, the merchant 22, the acquirer 1008, the issuer 1004, a financial institution, or combinations thereof. The transaction handler 1006 may maintain a log or history of authorized transactions. Once approved, the merchant 22 can record the authorization and allow the consumer 1002 to receive the good or service.

The merchant 22 may, at discrete periods, such as the end of the day, submit a list of authorized transactions to the acquirer 1008 or other components of the payment processing system 1000. The transaction handler 1006 may compare the submitted authorized transaction list with its own log of authorized transactions. If a match is found, the transaction handler 1006 may route authorization transaction amount requests from the corresponding acquirer 1008 to the corresponding issuer 1004 involved in each transaction. Once the acquirer 1008 receives the payment of the authorized transaction amount from the issuer 1004, it can forward the payment to the merchant 22 less any transaction costs, such as fees. If the transaction involves a debit or pre-paid card, the acquirer 1008 may choose not to wait for the initial payment prior to paying the merchant 22.

There may be intermittent steps in the foregoing process, some of which may occur simultaneously. For example, the acquirer 1008 can initiate the clearing and settling process, which can result in payment to the acquirer 1008 for the amount of the transaction. The acquirer 1008 may request from the transaction handler 1006 that the transaction be cleared and settled. Clearing includes the exchange of financial information between the issuer 1004 and the acquirer 1008 and settlement includes the exchange of funds.

The transaction handler 1006 can provide services in connection with clearing and settlement of the transaction. For example, the clearing and settlement of the transaction that involves credit may occur after the authorization of the transaction. The settlement of a transaction involves an issuer 1004 withdrawing an amount of a transaction settlement from a clearinghouse, such as an issuer clearing bank, for deposit into a settlement house, such as a settlement bank. The transaction handler 1006 deposits the amount of the transaction settlement into an acquirer clearing bank. The corresponding acquirer 1008 withdraws the amount of the transaction settlement from the acquirer clearing bank. Typically, the issuer 1004 chooses the issuer clearing bank, the transaction handler 1006 chooses the settlement back, and the acquirer chooses the clearing bank. When the transaction involves debit, the clearing may occur during the authorization process. Thus, a typical transaction involves various entities to request, authorize, and fulfill the processing of the transaction for clearing and settlement.

Various terms may be used herein, which are to be understood according to the following descriptions 1 through 5:

1. The portable consumer device 1012 includes a card, smartcard, ordinary credit or debit cards (with a magnetic strip and without a microprocessor), a keychain device (such as the SPEEDPASS® commercially available from Exxon-Mobil Corporation), cellular phone, personal digital assistant (PDA), pager, payment card, security card, access card, smart media, or transponder, where each portable consumer device can include a loyalty module with a computer chip with dedicated hardware, software, embedded software, or any combination thereof that is used to perform actions associated with a loyalty program;

2. Issuer includes any entity that issues one or more payment accounts and/or payment devices;

3. Merchant includes any entity that supports the POS device;

4. A consumer includes any person or entity with the payment account and/or a payment device associated with the payment account, where the payment account is within a transaction processing system such as: a person, entity, charitable organization, machine, hardware, software, merchant or business who accesses and uses the disclosed implementations, such as any consumer (such as primary member and supplementary member of an aggregate consumer payment account), retailer, manufacturer, and third-party provider, and any subset, group or combination thereof;

5. Reward or incentive includes any discount, credit, good, service, package, event, or experience (such as wine tasting, dining, travel).

The steps of a method, process, or algorithm described in connection with the implementations disclosed herein may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
forming, at a hand held consumer wireless telecommunications device, data sufficient to make a reservation with a reservation broker for an inventory to be received by a consumer from a merchant, wherein the data includes an indicator of a first payment account associated with a payment processing system;
receiving, at the hand held consumer wireless telecommunications device, a confirmation of the reservation with the reservation broker, whereby an incentive will be earned for a transaction associated with the reservation that is payable on a second payment account associated with the payment processing system that matches the first payment account.

2. The method as defined in claim 1, further comprising receiving notice, at the hand held consumer wireless telecommunications device, that the incentive has been earned for the transaction associated with the reservation which was payable on the second payment account which was matched with the first payment account.

3. The method as defined in claim 1, further comprising receiving notice, at the hand held consumer wireless telecommunications device, that the incentive will be earned for the transaction associated with the reservation which was payable on the second payment account associated within the payment processing system upon the finding of the match with the first payment account.

4. The method as defined in claim 1, wherein the data to make the reservation is in a plurality of transmissions each being formed at the hand held consumer wireless telecommunications device during an on-line, real-time interactive session.

5. The method as defined in claim 1, further comprising forming, during the transaction, at the hand held consumer wireless telecommunications device, a transmission addressed to the payment processing system and including an identifier for each of the second payment account, an indicator of the merchant, and a description of the inventory received by the consumer from the merchant.

6. The method as defined in claim 1, wherein the incentive is selected from the group consisting of:
money;
a reward in a frequent traveler program with which the consumer is associated;
a reward in a consumer loyalty program associated with the first payment account;
a good;
a service;
a credit to the second payment account; and
combinations thereof.

7. The method as defined in claim 1, wherein the hand held consumer wireless telecommunications device is selected from the group consisting of a cellular telephone, a hand held computer, a personal digital assistant, a pager, a smart media device, a transponder, a laptop personal computer, a virtual cash register, and a combination thereof.

8. The method as defined in claim 1, further comprising, prior to the forming, receiving an invitation at the hand held consumer wireless telecommunications device to make the reservation with the reservation broker for the inventory to be received by the consumer from the merchant.

9. The method as defined in claim 8, wherein the invitation includes a description of the incentive that can be earned for the transaction associated with the reservation that is payable on the second payment account that matches the first payment account.

10. The method as defined in claim 1, wherein the incentive is derived, at least in part, based on a factor selected from the group consisting of:
the length of time between the receiving of the confirmation of the reservation and the transaction;
a date of the transaction;
a time of day of the transaction;
a monetary value of the transaction;
a number in a party for the reservation;
the inventory;
the number of previous said reservations that were found to correspond to respective previous said transactions for which there was a match, respectively, of the first and second payment accounts; and
a combination thereof.

11. The method as defined in claim 1, wherein the reservation includes a plurality of said reservations in a chronological sequence.

12. The method as defined in claim 1, further comprising, prior to the forming, creating, at the hand held consumer wireless telecommunications device, a designation directing the incentive to be applied as a credit to the first payment account.

13. The method as defined in claim 1, further comprising, at the hand held consumer wireless telecommunications device:
forming a request for information about one or more past said reservations; and
receiving the information, wherein the information for each said past reservation is selected from the group consisting of:
a previously formed reservation;
a previously conducted transaction payable on the second payment account corresponding to a previous reservation;
a previously received incentive based on a previous match between the first payment account and second payment account;
a previous length of time between the previously formed reservation and the previously conducted transaction;
a date of previously conducted transaction;
a time of day of the previously conducted transaction;
a value of the previously conducted transaction;
a number in a party for previously formed reservation;
the inventory associated with the previously formed reservation;
the incentive associated with the previously formed reservation; and
a combination thereof.

14. The method as defined in claim 1, wherein the payment processing system includes a transaction handler processing a plurality of transactions each characterized by the merchant and the consumer engaging in the transaction upon the second payment account that an issuer has issued to the consumer, wherein the merchant submits the transaction to an acquirer for processing by the transaction handler who requests the issuer to obtain payment for the transaction from the consumer, and wherein the issuer forwards the payment to the transaction handler who forwards the payment to the acquirer to pay the merchant for the transaction.

15. Any hand held consumer wireless telecommunications device having a processor executing a program to:
form a first transmission having data sufficient to make a reservation with a reservation broker, wherein the data includes an indicator of a first payment account associated with a payment processing system;
receive a second transmission including a confirmation of the reservation; and
receive a third transmission including information characterizing an incentive for each match of the first payment account for the reservation with a second payment account associated with the payment processing system, wherein a transaction associated with the reservation is payable on the second payment account.

16. The hand held consumer wireless telecommunications device as defined in claim 15, wherein the program further includes code which, when executed by the processor executes a transaction application used to conduct the transaction associated with the reservation payable on the second payment account.

17. The hand held consumer wireless telecommunications device as defined in claim 15, wherein the first transmission further comprises data selected from the group consisting of:
a name of a consumer associated with the first payment account;
a username for the consumer;
a password for the consumer;
a type of payment account associated with the first payment account;
the incentive that the consumer pre-selected;
an amount of the incentive;
a date of the reservation;
a time of the reservation;
a name of a merchant having inventory corresponding to the reservation;
a description of an inventory corresponding to the reservation;
a category code for the merchant;
a number in a party corresponding to the reservation;
and combinations thereof.

18. The hand held consumer wireless telecommunications device as defined in claim 15, wherein the hand held consumer wireless telecommunications device is selected from the group consisting of: a hand held wireless communication device, a cellular telephone, a hand held computer, a personal digital assistant, a pager, a smart media, a transponder, a laptop personal computer, a virtual cash register, and a combination thereof.

19. The hand held consumer wireless telecommunications device as defined in claim 15, wherein the payment processing system includes a transaction handler processing a plurality of transactions each characterized by the merchant and the consumer engaging in the transaction upon the second payment account that an issuer has issued to the consumer, wherein the merchant submits the transaction to an acquirer for processing by the transaction handler who requests the issuer to obtain payment for the transaction from the consumer, and wherein the issuer forwards the payment to the transaction handler who forwards the payment to the acquirer to pay the merchant for the transaction.

20. A method comprising:
forming, at a portable consumer device, a first transmission having data sufficient to make a reservation with a reservation broker for a party at a restaurant, wherein the data includes:
an indicator of a first payment account associated with a payment processing system,
a number of expected people in the party,
a date of the reservation, and
a time of the reservation;
receiving, at the portable consumer device, a second transmission including a confirmation of the reservation; and
receiving information characterizing an incentive for each match of the first payment account for the reservation with a second payment account associated with the payment processing system, wherein a transaction associated with the reservation is payable on the second payment account.

21. The method as defined in claim 20, wherein the information characterizing the incentive is a value of the incentive that is received in a third transmission at the portable consumer device.

22. The method as defined in claim 20, wherein the payment processing system includes a transaction handler processing a plurality of transactions each characterized by the merchant and the consumer engaging in the transaction upon the second payment account that an issuer has issued to the consumer, wherein the merchant submits the transaction to an acquirer for processing by the transaction handler who requests the issuer to obtain payment for the transaction from the consumer, and wherein the issuer forwards the payment to the transaction handler who forwards the payment to the acquirer to pay the merchant for the transaction.

23. The method as defined in claim 20, wherein the first transmission includes a plurality of transmissions as the data is entered into the portable consumer device during an interactive session.

24. The method as defined in claim 20, further comprising, prior to the forming of the first transmission, receiving at the portable consumer device, information about the restaurant as an invitation to make the reservation for the party at the restaurant.

25. The method as defined in claim 20, further comprising forming, at the portable consumer device, a third transmission addressed to the payment processing system, the third transmission including an indicator of the second payment account.
